(19) United States
(12) Patent Application Publication
(10) Pub. No.: US 2022/0407985 A1
(43) Pub. Date: Dec. 22, 2022

(54) INTEGRATED LIGHTING AND SOUND DEVICE

(71) Applicant: FOSHAN LECHENG PHOTOGRAPHIC EQUIPMENT CO., LTD, FOSHAN (CN)

(72) Inventor: JIAN WEN MAI, FOSHAN (CN)

(21) Appl. No.: 17/842,745

(22) Filed: Jun. 16, 2022

(30) Foreign Application Priority Data
Jun. 16, 2021 (CN) 202110676708.9

(51) Int. Cl. H04N 5/222; H04R 1/08; G06F 3/16

(52) U.S. Cl. CPC H04N 5/222; H04R 1/08; G06F 3/16

(57) ABSTRACT

An integrated lighting and sound device includes an LED lamp sheet, a beautifying live broadcast lamp front cover, a microphone output port, a beautifying live broadcast lamp rear cover, and a sound card circuit board. The sound card circuit board is embedded in the beautifying live broadcast lamp rear cover and belongs to a part of the sound card module, and the sound card module includes a plurality of sound production modes. A sound card, a microphone, and the LED lamp sheet achieve a switch between beautifying, live talking, and live voice changing at the same time. The present disclosure saves time of switching live broadcast devices back and forth and space of working environment, increases working efficiency of a live broadcast, and reduces a purchase cost.

### TECHNICAL FIELD

The present disclosure relates to a technical field of live broadcast devices, in particular to a beautifying live broadcast lamp, and especially to an integrated lighting and sound device.

### BACKGROUND

A live broadcast is defined by radio and television dictionary as “a broadcasting method in which post-synthesis and broadcast of radio television programs are carried out at the same time”. The live broadcast is divided into an on-site live broadcast, a radio studio live broadcast, and a television studio live broadcast, etc. according to broadcasting occasions. The on-site live broadcast is a broadcasting method to simultaneously produce and broadcast a television program with occurrence and development of events on scene, which fully reflects advantages of radio and television media communication. The live broadcast is named as LIVE abroad. At present, the live broadcast mostly refers to a network live broadcast.

A live broadcast shooting does not have post-processing, which requires excellent surrounding environment, such as light, otherwise image quality may be poor, which may affect experience effect of audiences, thus a beautifying live broadcast lamp occurs. The beautifying live broadcast lamp may bring in light during the live broadcast shooting, so that the image quality is good. In addition, the live broadcast shooting further requires excellent sound quality, if the sound quality is poor, an effect of the live broadcast is greatly reduced.

However, in a process of implementing technical solutions in prior art, the applicant finds following technical problems in the technical solutions in the prior art:

The present LED beautifying live broadcast lamp only has a single beautifying light function, which requires a sound card and a microphone to complete live broadcast work in an actual live broadcast. The sound card and the microphone further take time to debug, which are very inconvenient to carry especially when outdoors or in a mobile scene, and the live broadcast requires collaboration of multiple people to complete.

### SUMMARY

In order to solve a technical problem in the prior art, that a beautifying live broadcast lamp only has a single beautifying light function, which may not meet requirements of beautifying, live talking, and live voice changing at the same time, the present disclosure provides an integrated lighting and sound device. The present disclosure at least achieves one of technical effects of saving time of switching the live broadcast devices back and forth and space of working environment, increasing working efficiency of a live broadcast, and reducing a purchase cost.

In order to solve above technical problems, the present disclosure provides a technical scheme of an integrated lighting and sound device, including an LED lamp sheet, a beautifying live broadcast lamp front cover, a microphone output port, a beautifying live broadcast lamp rear cover, and a sound card circuit board.

The LED lamp sheet is located in a middle of the integrated lighting and sound device, and the LED lamp sheet is configured to provide different lights.

The beautifying live broadcast lamp front cover is disposed at a first end of the LED lamp sheet.

The microphone output port is disposed in the beautifying live broadcast lamp front cover and belongs to a part of a microphone module. The microphone module is electrically connected with a sound card module and is configured to receive sound.

The beautifying live broadcast lamp rear cover is disposed at a second end of the LED lamp sheet where the second end of the LED lamp sheet is one end distal from the beautifying live broadcast lamp front cover.

The sound card circuit board is embedded in the beautifying live broadcast lamp rear cover and belongs to a part of the sound card module. The sound card module includes a plurality of sound production modes.

A sound card and a microphone are disposed in the integrated lighting and sound device, the integrated lighting and sound device combines the sound card, the microphone, and the LED lamp sheet to achieve a switch between beautifying, live talking, and live voice changing is realized at the same time.

Optionally, the sound card module includes one or more of following sound production modes: a robot mode, a male-to-female mode, a female-to-male mode, a phonograph mode, a telephone sound mode, a girl voice mode, and a magic mode. Different modes are transformed according to an actual scene.

Optionally, the sound card module further includes one or more of following sound production modes: a duck mode, a karaoke mode, a microphone mode, an original sound mode, and a sound breaking mode, so that different sounds are added when the different modes are transformed in the actual scene.

Optionally, the sound card circuit board further includes a USB port, a color temperature adjusting key, a brightness adjusting key, a music play key, a MAC volume key, and a volume monitoring key.

Optionally, a range of color temperatures of the LED lamp sheet is 2800 K-10000 K.

Optionally, a plurality of dissipation holes are defined on the beautifying live broadcast lamp rear cover to allow air flow to take away heat.

The present disclosure further provides a remote controller configured for the above integrated lighting and sound device.

### BRIEF DESCRIPTION OF DRAWINGS

FIG. 1 is a structural schematic diagram of an integrated light and sound device according to one embodiment of the present disclosure.

FIG. 2 is a schematic diagram of a circuit of the integrated light and sound device according to one embodiment of the present disclosure.

FIG. 3 is a schematic diagram of an application scenario of the FIG. 2 Reference number in the figures: microphone output/remote controller receiver 1, beautifying live broadcast lamp front cover 2, LED lamp sheet 3, sound card circuit board 4, beautifying live broadcast lamp rear cover 5, USB port 6, color temperature adjusting key/headphone 7, brightness adjusting key/headset 8, music play key/microphone 9, MAC volume key/live broadcast 10, volume monitoring key/accompaniment 11, remote control/instrument 12, color temperature 13, and brightness 14.

### DETAILED DESCRIPTION

Specific embodiments of the present disclosure are further described below with reference to accompanying drawings. Description of the embodiments is configured to help understand the present disclosure, but does not constitute a limitation to the present disclosure. In addition, each two of technical features involved in the various embodiments of the present disclosure described below may be combined as long as no conflict exists between the two of the technical features.

A beautifying live broadcasting lamp on market now only has a single beautifying light function, and if voice changing and live talking are needed, an external sound card and an external microphone are further needed to be connected. When beautifying, live talking, and live voice changing are realized at the same time, multiple live broadcast devices need to be switched back and forth, resulting in a waste of time and a certain limitation on space of working environment, which further affects working efficiency of a live broadcast, and a purchase cost is increased when external functional components are purchased to overcome above problems.

The present disclosure provides a technical solution of an integrated lighting and sound device, solving a technical problem that in the prior art, the beautifying live broadcast lamp only has a single beautifying light function, which may not meet requirements of the beautifying, the live talking, and the live voice changing at the same time. An integrated sound card and an integrated microphone combine an LED lamp sheet 3 to achieve a beneficial effect of saving the time for the live broadcast device to switch back and forth and the space of working environment, increasing the working efficiency of the live broadcast, and reducing the purchase cost.

In order to solve above technical problems, a general idea of a technical solution of the present disclosure is as follows:

The present disclosure provides the integrated lighting and sound device, adopting an LED beautifying live lamp having a sound card and a microphone which is achieved by a series of technical means such as adding the sound card and the microphone in the original LED beautifying live lamp, to obtain an LED beautifying live lamp with the sound card and the microphone inside. The sound card module includes a plurality of sound production modes for different scenes to use. The integrated lighting and sound device is equipped with a remote control 12.

In order to better understand the above technical solution, the above technical solution is described in detail below with reference to the accompanying drawings and the specific embodiments.

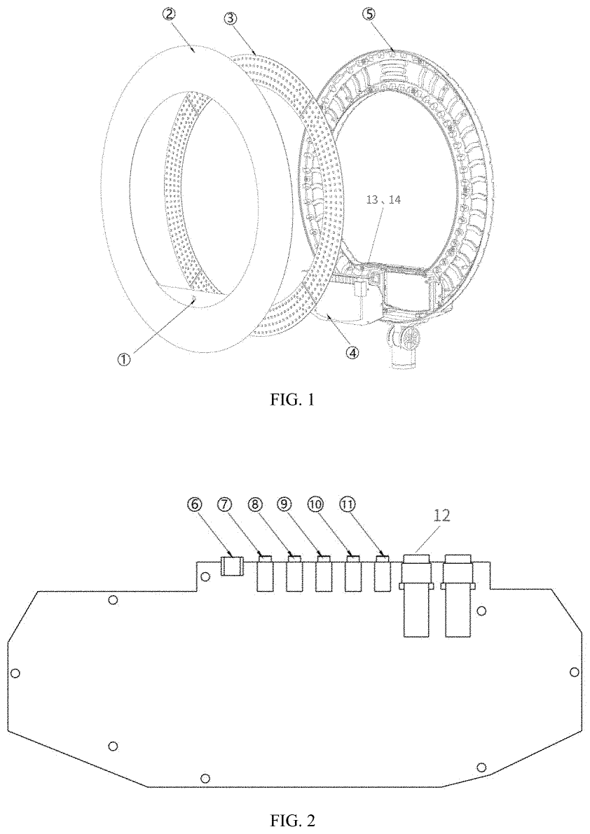

The integrated lighting and sound device, as shown in FIG. 1, includes the LED lamp sheet 3, a beautifying live broadcast lamp front cover 2, a microphone output port 1, a beautifying live broadcast lamp rear cover 5, and a sound card circuit board 4.

The LED lamp sheet 3 is located in a middle of the integrated lighting and sound device, and the LED lamp sheet 3 is configured to provide different lights. Various lamp effects are obtained by the different lights. A range of color temperatures of the LED lamp sheet 3 is 2800 K-10000 K.

Optionally, a plurality of dissipation holes are defined on the beautifying live broadcast lamp rear cover 5 to allow air flow to take away heat.

Furthermore, the beautifying live broadcast lamp front cover 2 is disposed at a first end of the LED lamp sheet 3.

Furthermore, the microphone output port 1 is disposed in the beautifying live broadcast lamp front cover 2 and belongs to a part of the microphone module, the microphone module is electrically connected with the sound card module and is configured to receive sound.

Furthermore, the beautifying live broadcast lamp rear cover 5 is disposed at a second end of the LED lamp sheet 3 where the second end of the LED lamp sheet 3 is one end distal from the beautifying live broadcast lamp front cover 5.

Furthermore, the sound card circuit board 4 is embedded in the beautifying live broadcast lamp rear cover 5 and belongs to a part of the sound card module, and the sound card module includes the plurality of sound production modes.

Furthermore, the sound card and the microphone are disposed in the integrated lighting and sound device, the integrated lighting and sound device combines the sound card, the microphone, and the LED lamp sheet 3 to achieve a switch between the beautifying, the live talking, and the live voice changing is realized at the same time.

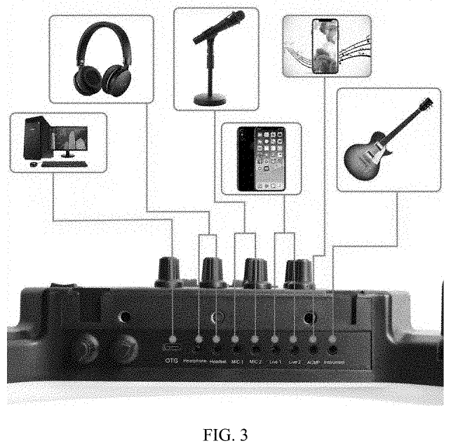

Specifically, as shown in FIG. 2, the sound card circuit board 4 includes a USB port 6, a color temperature adjusting key 7, a brightness adjusting key 8, a music playing key 9, a MAC volume key 10, and a volume monitoring 11.

The sound card circuit board 4 may be further arranged according to following ports: a remote controller receiver 1, the beautifying live broadcast lamp front cover 2, the LED lamp sheet 3, the sound card circuit board 4, the beautifying live broadcast lamp rear cover 5, an USB port 6, a headphone 7, a headset 8, the microphone 9, a live broadcast 10, an accompaniment 11, an instrument 12, a color temperature 13, and a brightness 14.

Specifically, the LED beautifying live lamp having the sound card and the microphone is integrated by combining the sound card circuit, the microphone circuit, and the remote control circuit, which is more convenient during live broadcasting. A beautifying live broadcast lamp on market now only has a single beautifying light function, and if the voice changing and the live talking are needed, the external sound card and the external microphone are further needed to be connected. Compared with the beautifying live broadcast lamp on the market, the LED beautifying live broadcast lamp having the sound card and the microphone is provided with the microphone and the sound card inside, which meets the requirements of the beautifying, the live talking, and the live voice changing at the same time, making the LED beautifying live broadcast lamp more convenient to use, saving the time of switching the live broadcast devices back and forth and the space of working environment, increasing the working efficiency of the live broadcast, and reducing the purchase cost.

The external application scene of the integrated lighting and sound device is shown in FIG. 3, and two knobs on leftmost side are the knobs configured to adjust the color temperature 13 and the brightness 14.

The sound card switch key activates the sound card function, and the microphone is further turned on at the same time.

A control panel of the sound card is provided with different sound effects to meet different uses of live broadcast scenes.

Two volume keys are configured to adjust a volume level, and a plurality of mixing modes (sound production modes) may be realized at the same time by adjusting the volume keys.

Specifically, the mixing modes include a robot mode, a male-to-female mode, a female-to-male mode, a phonograph mode, a telephone sound mode, a girl voice mode, and a magic mode. Different modes are transformed according to an actual scene.

In addition, the sound card module further includes one or more of following sound production modes: a duck mode, a karaoke mode, a microphone mode, an original sound mode, and a sound breaking mode, so that different sounds are added when the different modes are transformed in the actual scene.

A circuit board of the sound card and a circuit board of the microphone are embedded into a circuit board of the beautifying live broadcast lamp, and the integrated circuit board of the beautifying live broadcast lamp is optimized, so that the beautifying live broadcast lamp has functions of an LED lamp, the microphone, and the sound card. In addition, the beautifying live broadcast lamp is further equipped with a remotely controllable function, and the remote control 12 is configured to control a desired effect in the live broadcast.

Multifunctional integrated circuit board is often a circuit board having a large electronic component density, heat generated by the multifunctional integrated circuit board increases as operation of the multifunctional integrated circuit board speeds up, thus when temperature of the multifunctional integrated circuit board is too high, a situation that work is abnormal may occur.

In order to avoid a problem of overheating of the circuit board, a plurality of dissipation holes are defined on the beautifying live broadcast lamp rear cover 5 to allow air flow to take away heat, thereby improving a heat dissipation effect. The plurality of heat dissipation holes are fully defined on the beautifying live broadcast lamp rear cover 5, and the plurality heat dissipation holes occupy ⅓ of surface area of the beautifying live broadcast lamp rear cover 5.

Components included in the specific embodiments of the present disclosure may be selected from a conventional electronic product mall.

One or more technical solutions provided by the embodiments of the present disclosure at least have following technical effects or advantages:

According to the above technical solution, the series of technical means such as the sound card module and the microphone module are disposed in the LED beautifying live lamp having the sound card and the microphone, so that the LED beautifying live lamp is provided with the sound card and the microphone inside. The present disclosure solves the technical problem in the prior art that if the voice changing and the live talking are needed, the external sound card and the external microphone are further needed to be connected, thereby saving the time of switching the live broadcast devices back and forth and the space of working environment, increasing the working efficiency of the live broadcast, and reducing the purchase cost.

The embodiments of the present disclosure are described in detail above with reference to the accompanying drawings, but the present disclosure is not limited to the described embodiments. For a person skilled in art, without departing from principle and spirit of the present disclosure, various changes, modifications, substitutions and variations to the embodiments still fall within the protection scope of the present disclosure.

What is claimed is:

1. An integrated lighting and sound device, comprising:
an LED lamp sheet;
a beautifying live broadcast lamp front cover;
a microphone output port;
a beautifying live broadcast lamp rear cover; and
a sound card circuit board;
wherein the LED lamp sheet is located in a middle of the integrated lighting and sound device, and the LED lamp sheet is configured to provide different lights;
the beautifying live broadcast lamp front cover is disposed at a first end of the LED lamp sheet;
the microphone output port is disposed in the beautifying live broadcast lamp front cover and belongs to a part of a microphone module, the microphone module is electrically connected with a sound card module and is configured to receive sound;
the beautifying live broadcast lamp rear cover is disposed at a second end of the LED lamp sheet where the second end of the LED lamp sheet is one end distal from the beautifying live broadcast lamp front cover;
the sound card circuit board is embedded in the beautifying live broadcast lamp rear cover and belongs to a part of the sound card module; the sound card module comprises a plurality of sound production modes; and
a sound card and a microphone are disposed in the integrated lighting and sound device, the integrated lighting and sound device combines the sound card, the microphone, and LED lamp sheet to achieve a switch between beautifying, live talking, and live voice changing is realized at the same time.

2. The integrated lighting and sound device according to claim 1, wherein the sound card module comprises one or more of following sound production modes:
a robot mode, a male-to-female mode, a female-to-male mode, a phonograph mode, a telephone sound mode, a girl voice mode, and a magic mode; and different modes are transformed according to an actual scene.

3. The integrated lighting and sound device according to claim 2, wherein the sound card module further comprises one or more of following sound production modes:
a duck mode, a karaoke mode, a microphone mode, an original sound mode, and a sound breaking mode;
so that different sounds are added when the different modes are transformed in the actual scene.

4. The integrated lighting and sound device according to claim 1, wherein the sound card circuit board comprises a USB port, a color temperature adjusting key, a brightness adjusting key, a music play key, a MAC volume key, and a volume monitoring key.

5. The integrated lighting and sound device according to claim 1, wherein a range of color temperatures of the LED lamp sheet is 2800 K-10000 K.

6. The integrated lighting and sound device according to claim 1, wherein a plurality of dissipation holes are defined on the beautifying live broadcast lamp rear cover to allow air flow to take away heat.

7. A remote controller, wherein the remote controller is configured for the integrated lighting and sound device according to claim 1.
